(19) United States
(12) Patent Application Publication
(10) Pub. No.: US 2006/0218164 A1
(43) Pub. Date: Sep. 28, 2006

(54) Document management device and document management program

(75) Inventors: Kazumi Shinmura, Kawasaki (JP); Takashi Nonaka, Shizuoka (JP); Michiko Kawano, Kawasaki (JP); Naoko Funayama, Kawasaki (JP); Kosuke Tanaka, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/186,447

(22) Filed: Jul. 21, 2005

(30) Foreign Application Priority Data
Mar. 23, 2005 (JP) 2005-084859

(51) Int. Cl. G06F 7/00

(52) U.S. Cl. 707/100

(57) ABSTRACT

Disclosed is a document management device capable of sharing documents in such a form that each user can simply search out the required document. The document management device has a configuration of operating in such a status that after some users have executed the operation of setting the disclosing destinations in some self-containers and after some users have performed the operation of setting the browsing request destinations in the self partner view containers, the container names of the containers possessed by the users designated as the browsing request destinations by the user of the partner view container and related to the container group in which the owner designates these users as the disclosing destinations, are displayed under the partner view container.

### BACKGROUND OF THE INVENTION

1. Field of the Invention

The present invention relates to a document management device and a document management program for managing documents (files etc.).

2. Description of the Related Art

As known well, in an office etc., computers connected to each other via a network (users of the computers) share the files with each other. Further, a technology (refer to, e.g., Japanese Patent Application Publication No.2003-157259) for sharing a search result is also developed.

Every conventional information sharing technology is, however, such that various items of information such as an information name etc. of the designated-by-owner sharing information are all displayed on a PC on the side of a user who employs the information. In other words, the conventional information sharing technology has such a problem that each individual user is unable to simply search out the information required by the user himself or herself.

### SUMMARY OF THE INVENTION

Under such circumstances, the present invention aims at providing a document management device and a document management program capable of sharing documents in such a form that each user can simply search out the required document (a file etc.).

To obviate the problems given above, a document management device according to a first mode of the present invention comprises disclosing target designating information storage means for storing, with respect to each of a plurality of management target documents, disclosing target designating information showing a document owner and several use-enabled users permitted to use the document, owner designating information storage means for storing, with respect to each of a plurality of users, owner designating information showing several document owners of the documents that the user desires to use, and name information sending-back means for specifying, when a predetermined request is sent from a computer used by a certain user, all the documents possessed by any one of the owners indicated by the owner designating information stored on the owner designating information storage means with respect to the user concerned and of which the users are included in the use-enabled users indicated by the disclosing target designating information stored on the disclosing target designating information storage means from within the plurality of documents, and sending the name information about the specified document group back to the computer.

Namely, the document management device according to the first mode of the present invention has a configuration of operating in such a status that each document owner stores the disclosing target designating information on the disclosing target designating information storage means, some users store the owner designating information on the owner designating information storage means, and, with this contrivance, when the predetermined request is sent from the computer employed by a certain user, the name information about the document group possessed by any one of the owners designated by the user concerned and in which the document owner designates that the user is the use-enabled user, is sent back to the computer. Accordingly, the use of this document management device makes it possible not to display, on the display of the computer, the names etc. of the documents unnecessary to the user even when the owners disclose the documents and consequently to easily search out the document required by each user.

Further, a document management device according to a second mode of the present invention comprises a container information database capable of storing plural items of first type container information and plural items of second type container information on a user-by-user basis, first type container information registering means for registering, based on information inputted by a certain user, the container information database with the first type container information including container content information defined as information indicating several document identifiers (references to the documents), container names and disclosing target designating information defined as information for designating several use-enabled users permitted to use the container content information as information about the containers possessed by the users concerned, second type container information registering means for registering, based on the information inputted by a certain user, the container information database with the second type container information including the owner designating information indicating several owners of the documents that the user concerned desires to use as the information about the user concerned, container name request response means for searching, when a predetermined container name request is sent from a computer used by a certain user, the container information database for all the first type container information about the container possessed by any one of the owners designated by the owner designating information included in the second type container information in the container information database with respect to the user concerned and including the disclosing target designating information indicating that the user concerned is the use-enabled user, and transmitting, to a computer that has transmitted the list information request, the container name information including the container names in the retrieved first type container information, the container names being displayed on a display of the computer, and document identifier request response means for transmitting, when a document identifier request including a container name is sent from a computer that performs displaying based on the container name information, document identifier information stored on the container information database and including all of several document identifiers of the documents indicated by the container information in the first type container information including the container names, the document identifiers being displayed on the display of the computer.

Namely, the document management device according to the second mode of the present invention operates so that the first type information registering means and the second type container information registering means register plural items of first type container information and several items of second type container information on the container information database, and, when the predetermined container name request is sent from the computer used by the user on which the second type container information has been registered, only the container name of the container possessed by any one of the owners designated by the user concerned and of which the user is designated as the user-enabled user, is displayed on the display of the computer from within the container information database. Further, the document management device is provided also with a function (a document identifier request response means) of displaying the actual contents of the container on the display of the computer. Therefore, the document management device according to the second mode of the present invention also enables each user to easily search out the necessary document.

On the occasion of actualizing the document management device according to the second mode of the present invention, the first type container information registering means can adopt means for generating, as the container content information, the first type container information including dynamic container content information designating a document search condition or static container content information consisting of several document identifiers, and the document identifier request response means adopts means for searching for, if the first container information stored on the container information database and including the container name contained in the document identifier request includes the dynamic container content information as the container content information, a document satisfying the search condition designated by the dynamic container content information from within management target documents.

Further, the disclosing target designating information is information that includes several user names and several group names as the case may be, and the container name request response means can adopt means for dealing with the disclosing target designating information including the user name of the user and the disclosing target designating information including the group name of the group to which the user belongs as the disclosing target designating information indicating that the user is a use-enabled user.

Then, a document management program of the present invention serves to make a computer function as a device equal to the document management device according to the second mode of the present invention, and therefore it follows that an environment where each individual user can easily search out the necessary document can be actualized also by employing the document management program of the present invention.

### BRIEF DESCRIPTION OF THE DRAWINGS

These and other objects and advantages of the present invention will become clear from the following description with reference to the accompanying drawings, wherein:

FIG. 1 is a diagram of configuration of a document management device according to one embodiment of the present invention;

FIG. 2 is an explanatory diagram of a user information database provided on the document management device according to the embodiment;

FIG. 3 is an explanatory diagram of a document management page provided by the document management device;

FIGS. 4A-4C are explanatory diagrams of container configuration information stored on a container information database provided on the document management device;

FIGS. 5A and 5B are explanatory diagrams of the container configuration information stored on the container information database when registering user information;

FIG. 6 is a flowchart of processing executed by the document management device when receiving a document management page request;

FIG. 7 is an explanatory diagram of a container creation page provided by the document management device;

FIG. 8 is an explanatory diagram of a dynamic view setting page provided by the document management device;

FIG. 9 is an explanatory diagram of a disclosing destination setting page provided by the document management device;

FIG. 10 is an explanatory diagram of a document management page provided by the document management device;

FIG. 11 is an explanatory diagram of a partner view container update page provided by the document management device;

FIG. 12 is an explanatory diagram of a browsing request destination setting page provided by the document management device;

FIG. 13 is an explanatory diagram of a document management page provided by the document management device;

FIG. 14 is a flowchart of processing executed by the document management device when receiving a partner container information request;

FIG. 15 is an explanatory diagram of a document management page provided by the document management device;

FIGS. 16A-16D are explanatory diagrams of a container configuration information group used for displaying the document management page in FIG. 15; and

FIG. 17 is an explanatory diagram of a document management page provided by the document management device.

### DETAILED DESCRIPTION OF THE PREFERRED EMBODIMENTS

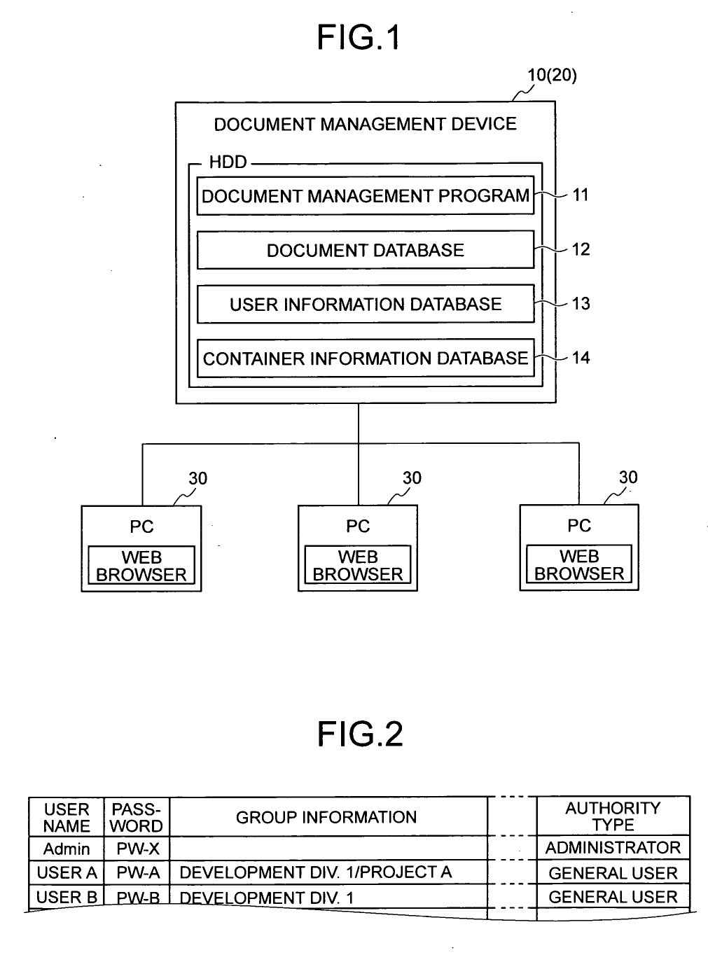

To start with, an outline of a document management device 10 according to one embodiment of the present invention will be described with reference to FIGS. 1 through 4.

As schematically shown in FIG. 1, the document management device 10 according to one embodiment of the present invention, is a computer 20 a HDD of which is stored with a document management program 11, a document database 12, a user information database 13, a container information database 14, OS (unillustrated) and so on. Further, the document management device 10 is employed in a way that connects via a network to some PCs (personal computers) 30 each preinstalled with Web browser.

The document management program 11 serves to make the document management device 10 (which is the computer 20 on which the self-program 11 runs) function as one type of Web application server.

The document database 12 serves to store a plurality of documents in a way that associates each document with various categories of attribute information (such as a creation date, an owner name, a document name, etc.). Note that the “document” is defined as a piece of file or an aggregation of several files in the present specification.

The user information database 13 is a database capable of storing, as schematically shown in FIG. 2, a plurality of records of user information each consisting of a user name, a password, group information, an authority type, etc. This user information database 13 is so structured as to be stored with only the user information when starting the operation of the document management device 10, wherein an initial value of an administrator name, an initial value of a password for the administrator and the “administrator” are set respectively in a “user name” field, a “password” field and an “authority type” field. Then, the document management device 10 and the document management program 11 are configured and structured so that only the administrator (who is identified with the user name and the password in the user information specified by “administrator” entered in the “authority type”) is assigned authority to register the user information in this user information database 13.

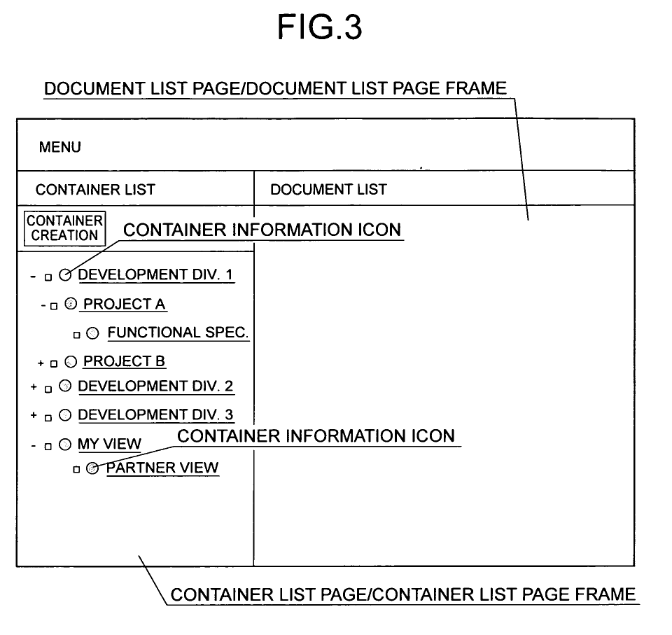

The container information database 14 is stored with pieces of information for displaying a document management page as shown in FIG. 3.

This document management page is a Web page on which to display a container list page showing container names (links; “DEVELOPMENT DIV. 1” etc.) related to a variety of fixed type containers and container names (links; “MY VIEW”, “PARTNER VIEW”) related to a variety of user containers possessed by browsers of the document management page together with checkboxes and container information icons within a frame for the container list page. Further, this document management page, when clicking the container name (link) on the container list page, also displays a document list page showing contents (document name list/container name list) of the associated container within a frame for the document list page.

Herein, the containers (the fixed type container, the user container) connote virtual containers for managing several documents (or several containers) within the document database 12 in a way that groups these documents. The fixed type container connotes a container created by the administrator etc. and usable in common by the users and the groups that are assigned access authority. Further, the user container represents an owner-fixed container (which is not categorized as the fixed type container but is the container created by each individual user as the user's own dedicated container). This user container includes the containers (the “MY VIEW” container and the “PARTNER VIEW” container in FIG. 3) employed by the document management device 10 as the containers for the individual users, and the containers created by the individual users as the user's own containers.

Then, the container information database 14 can be stored with, as pieces of information about the fixed type container, container hierarchical structure information representing a hierarchical structure of the fixed type containers, and with container configuration information that specifies a content/function of each fixed type container. At the same time, the container information database 14 can be stored with, as pieces of information about the user container, container hierarchical structure information representing a hierarchical structure (a parent-to-child relationship) of the user containers, and with container configuration information that specifies a content/function of each user container on a user-by-user basis (in the form of being associated with the user name and the group information).

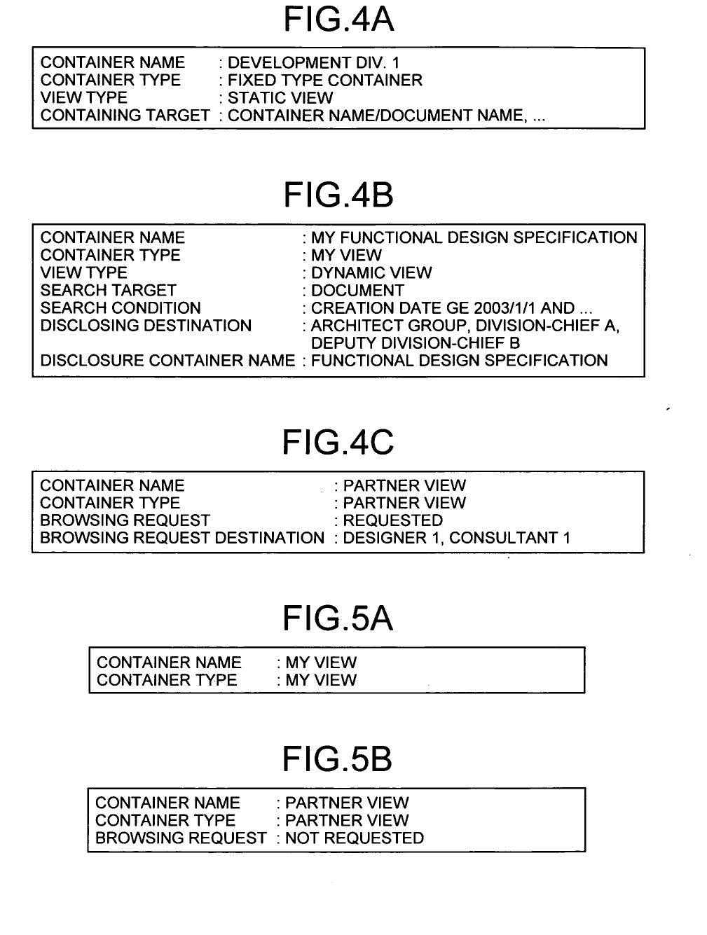

Moreover, the container information database 14 is stored with, as the container configuration information about each fixed type container, pieces of information (in which “fixed type container” is set as the container type) of a content as shown in FIG. 4A, and is also stored with, as the container configuration information about each user container, pieces of information (in which “My View” or “Partner View” is set as the container type; its details will be described alter on) of a content as shown in FIG. 4B or 4C.

Based on the premise of what has been described so far, an operation (a function/content of the document management program 11) of the document management device 10 according to the present embodiment will be specifically explained.

The document management device 10 according to the present embodiment is configured so that when some users create the user containers in which disclosing destinations (user names of other users etc.) are set or when setting the disclosing destinations of the already-created user containers and when some users set browsing request destinations (user names of other users etc.) of the partner view containers, the partner view container of a certain (arbitrary) user who performed the latter operation (setting) contains only the user container with the user designated as the disclosing destination in the user containers possessed by the individual users designated as the browsing request destination by this arbitrary user.

Given at first are explanations of a content of the operation carried out by the administrator in order to register the user information and of the operation (function) of the document management device 10 related to the administrator's operation.

The document management device 10 has a function of providing a user information setting page to the administrator (who was able to input the user name and the password in the user information (record) in which “administrator” is entered in the “authority type”). This user information setting page is a Web page having input boxes for various items of information structuring the user information, and a registration button for transmitting an HTTP (HyperText Transfer Protocol) request (which is to be received by the document management device 10 and will hereinafter be referred to as a user information registration request) including the information set in the respective input boxes when this button is pressed.

In short, the administrator, when registering the user information about a certain user, logs in the document management device 10 by use of the administrator's own username and password, thereby displaying the user information setting page on a display of the administrator's PC 30. Then, the administrator, after inputting the user name etc. onto the user information setting page, presses the registration button on the user information setting page.

In the case of receiving the user information registration request transmitted upon pressing the registration button, the document management device 10, to begin with, adds (registers) the user information consisting of the various items of information included in the user information registration request to the user information database 13 (see FIG. 2). Subsequently, the document management device 10 stores the container information database 14 with the container hierarchical structure information indicating that the partner view container exists under the my view container (see FIG. 3) the container configuration information (about the my view container) having the content shown in FIG. 5A and the container configuration information (about the partner view container) having the content shown in FIG. 5B as the information related to the user registered this time (in the form of being associated with the user name in the user information stored on the user information database 13 this time).

Then, the document management device 10, after notifying the administrator of a purport of completion of the user information by transmitting predetermined HTML (HyperText Markup Language) data to the transmission source PC 30 of the user information registration request, terminates the process for the received user information registration request.

Given next are descriptions of contents of the operation of creating the user container in which the disclosing destination is set, the operation of setting the disclosing destination in the already-created user container and the operation of setting the browsing request destination in the partner view container, and the operation (function) of the document management device 10 related to these operations.

These operations are performed by manipulating the document management page. Therefore, the user performing any one of the operations given above, at first, executes an operation (such as booting the web browser, inputting a predetermined URL (Uniform Resource Locator) to an address bar, and so on) for transmitting an HTTP request for the document management page (which will hereinafter be termed a document management page request) on the user's own PC 30.

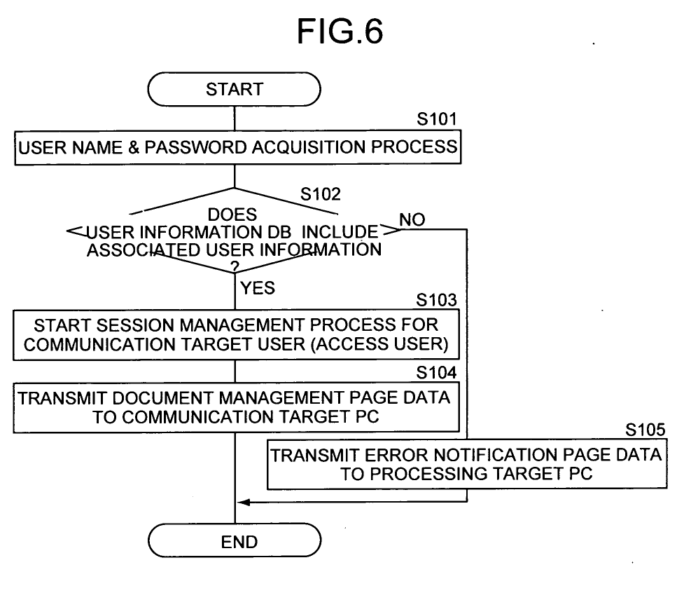

The document management device 10 receiving this document management page request executes processing in a procedure shown in FIG. 6.

To be specific, the document management device 10 receiving the document management page request at first executes a user name & password acquisition process for acquiring the user name and the password from an operator of a transmission source PC 30 (which will hereinafter be referred to as a communication target PC 30) of the document management page request (step S101). This user name & password acquisition process is, similarly to the process generally executed for acquiring the user name and the password, a process of displaying a so-called log-in dialog box on the display of the communication target PC 30.

The document management device 10 acquiring the user name and the password through the user name & password acquisition process judges whether or not the user information database 13 is stored with the user information (which will hereinafter be called associated user information) having the setting of the same user name and the same password as those acquired (step S102). Then, the document management device 10, if the user information database 13 is not stored with the associated user information (step S102; NO), transmits data for an error notification page to the communication target PC 30 (step S105), and thereafter finishes the process for the received document page request. Note that the data for the error notification page is HTML data enabling the communication target PC 30 (Web browser) to display the error notification page showing a message purporting that the inputted information is erroneous.

Whereas if the user information database 13 is stored with the associated user information (step S102; YES), the document management device 10, after grasping whether or not the operator (who will hereinafter be called a communication target user) of the communication target PC 30 has the access authority, starts a session management process (of handling a variety of requests transmitted afterward from the communication target PC 30 as requests from the communication target users) for the communication target user (step S103).

Then, the document management device 10, after transmitting the document management page data to the communication target PC 30 (step S104), terminates the process for the received document page request. Note that the document management page data are HTML data enabling the page to be displayed in the container list page frame on the basis of the HTML data transmitted as a response to a predetermined container list page request transmitted by the communication target PC 30 (Web browser) receiving the document management page data after this communication target PC 30 has displayed the Web page having the container list page frame etc.

In short, after completing the process in step S104, the container list page request is sent to the document management device 10 from the communication target PC 30.

The document management device 10 receiving this container list page request reads, from the container information database 14, the information (the container hierarchical structure information and the various items of container configuration information) about the fixed type container and the information (the container hierarchical structure information and the various item of container configuration information that are associated with the user name of the communication target user) about the user container of the communication target user. Then, the document management device 10 creates, based on the information read from the container information database 14, the HTML data (which will hereinafter be termed container list page data) used for the Web browser to display the container list page (see FIG. 3).

On this occasion, the container list page data created by the document management device 10, if the communication target user is the administrator, are organized to display the container list page on which all the checkboxes and all the container information icons can be manipulated. Further, whereas if the communication target user is not the administrator, the container list page data created by the document management device 10 are organized to display the container list page on which only the checkboxes and only the container information icons with respect to the fixed type container and the user container each having the authority equal to or higher than the right of reference, can be manipulated.

Furthermore, if the container configuration information about the partner view container that is read from the container information database 14 includes the information indicating that a browsing request is not made (see FIG. 5B), the container list page data created by the document management device 10 are organized to display the container list page (see FIG. 3) on which a “+” icon (for developing a container tree) with respect to the partner view container is not displayed.

While on the other hand, if the container configuration information about the partner view container includes the information indicating that the browsing request is made (see FIG. 4C), the container list page data created by the document management device 10 are organized for the communication target PC 30 (Web browser) receiving this to display the container list page on which the “+” icon with respect to also the partner view container is displayed, wherein when clicking this “+” icon, a predetermined HTTP request (which will hereinafter be referred to as a partner container information request) is sent to the document management device 10, and some container names (links) are displayed under the partner view container on the basis of the partner container information transmitted by the document management device 10 as a response to the partner container information request.

The document management device 10, which has created the container list page data described above, transmits the created container list page data to the communication target PC 30, and thereafter terminates the process for the received container list page request.

Given next are explanations of a content of the operation that must be conducted by the user for creating the user container in which the disclosing destination is set, and of an operation (function) of the document management device 10 related to the user's operation.

In the case of desiring to create the user container in which the disclosing destination is set, the user checks the checkbox (or the checkbox related to the container already created under the my view container) about the my view container on the container list page (see FIG. 3), and then presses a “container creation” button.

When this manipulation is done, the communication target PC 30 sends, onto the network, a container creation page request (an HTTP request that is to be received by the document management device 10) including the container name checked in the checkbox.

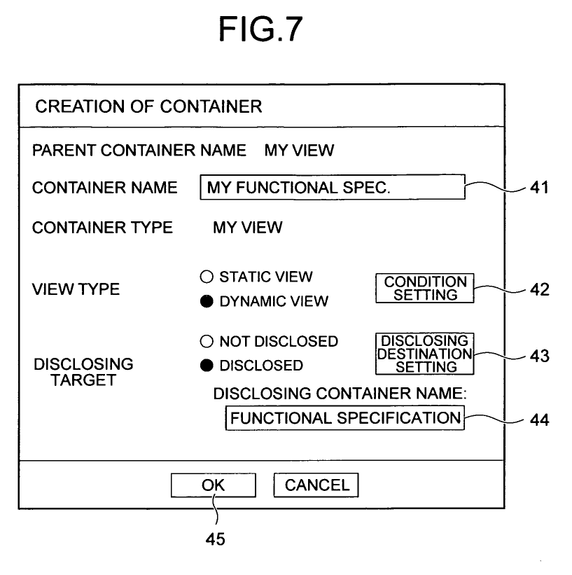

The document management device 10 receiving this container creation page request generates container creation page data for displaying a container creation page structured as shown in FIG. 7, and sends the generated data to the communication target PC 30. Then, the communication target PC 30 receiving the container creation page data displays the container creation page on a difference window.

Note that the container creation page displayed by pressing a “container creation” button showing nothing in a container name setting box 41 and in a disclosing container name setting box 44, wherein a status is that a “static view” radio button and a “not disclosed” radio button are selected. Further, the container creation page (in which a parent container name is “my view”, and the container type is “my view”) as illustrated in FIG. 7 is displayed when the user (the general user or the administrator) presses the “container creation” button after checking the checkbox related to the my view container. When the user presses the “container creation” button after checking the checkbox about the my view container, there is displayed the container creation page, wherein the parent container name is the container name of the container concerned, and the container type is “my view”. Further, when the administrator presses the “container creation” button after checking the checkbox about a certain fixed type container, there is displayed the container creation page including none of the various items for setting the disclosing destinations, wherein the parent container name is the container name of this fixed type container, and the container type is “fixed type container”.

The container name setting box 41 provided in the container creation page (FIG. 7) is an item for setting the container name of the container to be created. A “dynamic view” radio button is a button to be selected in the case of creating the container automatically containing a document/container that meets a designated search condition. The “static view” radio button is a button to be selected in the case of creating a container used for the user to individually designate the document/container contained therein.

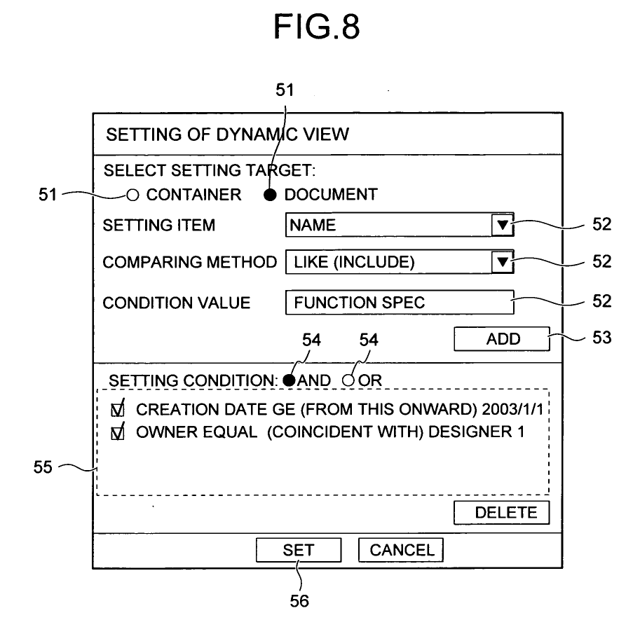

A condition setting button 42 is a button that is manipulatable only when the “dynamic view” radio button is selected. When this condition setting button 42 is pressed, a dynamic view setting page structured as shown in FIG. 8 is displayed in a new window.

The dynamic view setting page is a Web page, wherein a condition add button 53 is pressed after setting the search condition by use of three pieces of search condition designation items 52, and search condition information (“creation date GE (from this onward) 2003/1/1” etc.) indicating the set search condition is added to an already-set search condition display area 55. Further, the dynamic view setting page is structured so that the screen is closed by pressing a setting button 56.

Note that the HTTP request transmitted upon pressing the setting button 56 includes each piece of search condition information displayed in the already-set search condition display area 55, information indicating the radio button 51 selected, and information indicating the radio button 54 selected. Then, the document management device 10, when receiving the HTTP request sent by pressing the setting button 56, stores various items of information in this request in order to display the dynamic view setting page showing the already-set condition (and for use as information about the dynamic view set by the user) on the occasion of pressing the condition setting button 42 from the second time onward.

The “not disclosed” radio button on the container creation page (FIG. 7) is a button selected in the case of creating the container of which the content is not disclosed. The “disclosing” radio button is a button selected in the case of creating the container of which the content is disclosed.

The disclosing destination setting button 43 is structured to, when pressed, display a disclosing destination setting page for setting the disclosing destination in a new window. The disclosing container name setting box 44 is an item for setting a disclosing container name defined as a container name to be displayed on the document list page of other user. The disclosing destination setting button 43 and the disclosing container name setting box 44 are items that get manipulatable only when the “disclosing” radio button is selected.

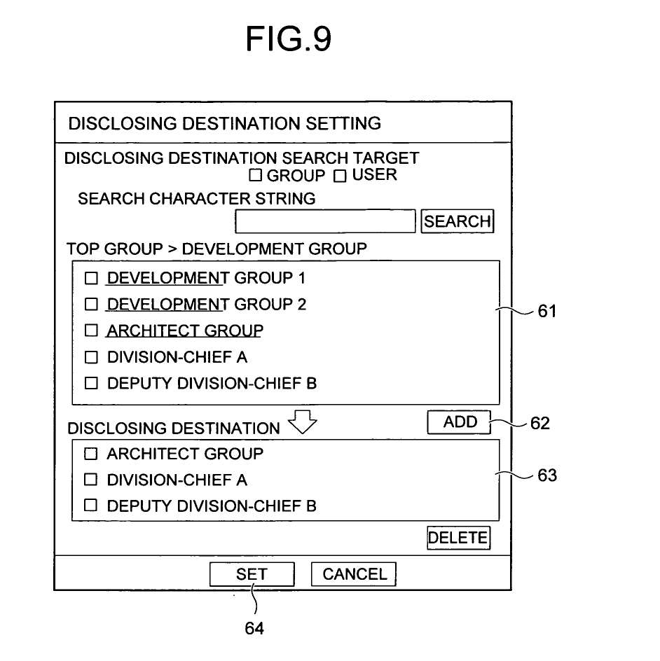

The disclosing destination setting page displayed by pressing the disclosing destination setting button 43 is a Web page provided with, as shown in FIG. 9, a disclosing destination selection area 61, an add button 62, an already-selected disclosing destination display area 63, a setting button 64, etc.

This disclosing destination setting page is a Web page taking an initial status, wherein a group name of each group having none of higher-order groups and a user name of each user who does not belong to any group, are displayed in the disclosing destination selection area 61. Further, the disclosing destination setting page is a Web page in which, when selecting a certain group name displayed in the disclosing destination selection area 61, the names of each group/user belonging to the group having the selected group name, are displayed in the disclosing destination selection area 61. Moreover, the disclosing destination setting page is a Web page in which, when pressing a “search” button after designating the search condition (a search target, a search character string), the names of each group/user that meet the designated search condition are displayed in the disclosing destination selection area 61.

Then, the disclosing destination setting page is a Web page, wherein each time the add button 62 is pressed, the names of the group/user checked in the checkboxes within the disclosing destination selection area 61 are displayed (added) in the already-selected disclosing destination display area 63, and the screen is closed when pressing the setting button 64.

Note that the HTTP request sent by pressing the setting button 64 includes the group name and the user name displayed in the already-selected disclosing destination display area 63. Then, the document management device 10, when receiving the HTTP request sent by pressing the setting button 64, stores the information in this request in order to display the disclosing destination setting page indicating the already-set disclosing destination (and for use as information about the disclosing destination set by the user) on the occasion of pressing the disclosing destination setting button 43 from the second time onward.

An OK button 45 on the container creation page (FIG. 7) is a button that should be pressed when completing the variety of settings.

When this OK button 45 is pressed, the communication target PC 30 executes a process of transmitting the HTTP request (which will hereinafter be referred to as a container creation request) including two categories of information showing the container name set in the container name setting box 41 and showing the disclosing container name set in the disclosing container name setting box 44 and the selected radio button as well, a process for causing the container list page to be reread (which is a process for transmitting the container list page request), and a process of closing the container creation page.

Then, the document management device 10, when receiving the container creation request, based on the information (such as the information set by manipulations on the disclosing destination setting page etc, and the search condition) stored as the information about the communication target user and based on the various items of information included in the container creation request, executes a process of adding the information about a creation-indicated container into the container information database 14 (which is the process of adding the information about the creation-indicated container to the container hierarchical structure information concerning the communication target user within the container information database 14, and adding the container configuration information (see FIG. 4B) representing the content/function of the creation-indicated container into the container information database 14).

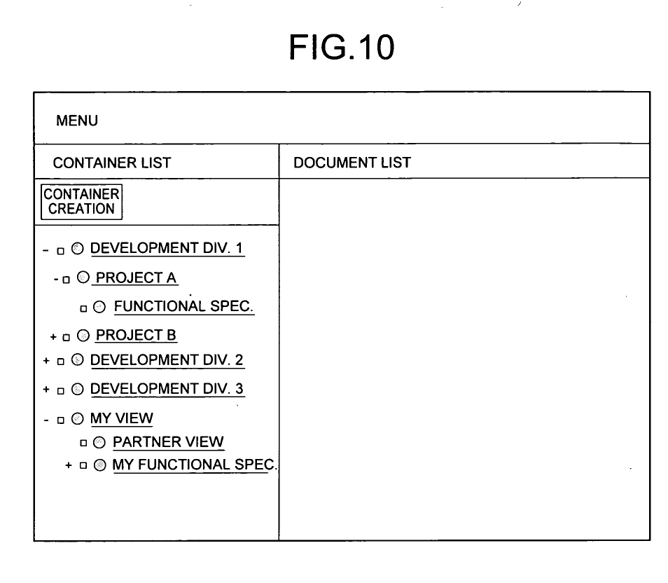

Further, as already explained, the document management device 10, when receiving the container list page request, generates the container list page data by use of the information (such as the container hierarchical structure information and the various items of container configuration information) about the user container of the communication target user within the container information database 14. Therefore, eventually, when the OK button on the container creation page is pressed, it follows that the content of the container list page is changed from, for example, the content shown in FIG. 3 into a content illustrated in FIG. 10.

Note that the user, in the case of desiring to set the disclosing destination in a certain user container created without setting any disclosing destination, clicks the container information icon related to this user container. When performing this manipulation, there is displayed a container update page (on which the container name etc. are displayed from the beginning) having the same configuration as the container creation page has, and hence the user presses the disclosing destination setting button after selecting the “disclosed” radio button on this container update page. Then, the user sets the disclosing destination by manipulation on the disclosing destination setting page (which is the same as the above-mentioned) displayed by pressing the disclosing destination setting button, and thereafter presses the OK button on the container update page.

Given next are explanations of a content of the operation that must be done for setting a browsing request destination in the partner view container and of an operation (function) of the document management device 10 related to the former operation.

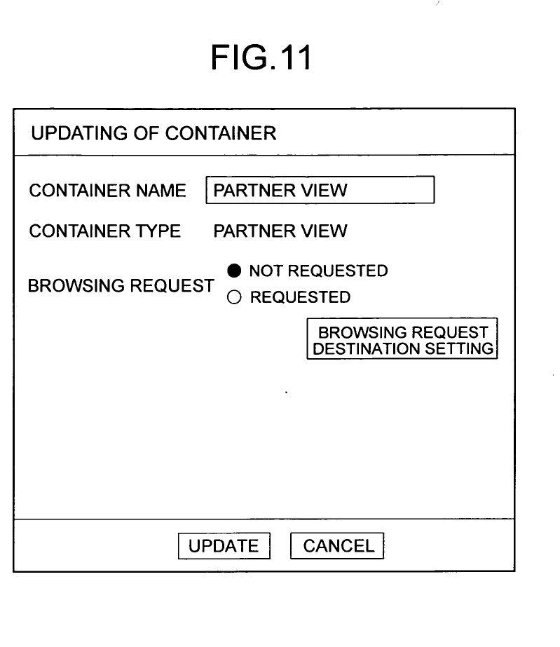

When setting the browsing request destination in the partner view container, the user clicks the container information icon related to the partner view container. When this manipulation is conducted, a partner view container update page having a configuration shown in FIG. 11 is displayed in a different window. Hence, the user presses a “browsing request setting” button after selecting a “request” radio button on this partner view container update page.

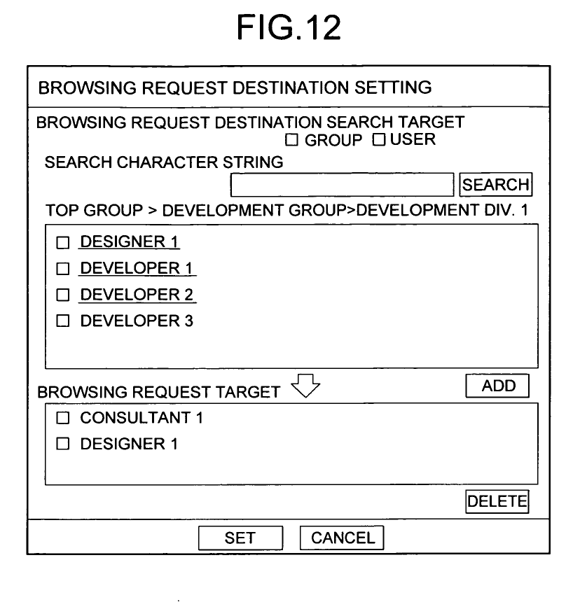

Upon performing this manipulation, there is displayed a browsing request destination setting page (a Web page enabling the same manipulation as on the disclosing destination setting page) shown in FIG. 12, and therefore the user presses the setting button after designating some browsing request destinations through the manipulation on this browsing request destination setting page. Then, the user presses an update button on the partner view container update page (FIG. 11) redisplayed by pressing the setting button.

When the update button on the partner view container update page is pressed, the communication target PC 30 (Web browser) executes a process of sending a HTTP request (which will hereinafter be referred to as a partner view container update request) including the information showing the container name set in the container name setting box and the radio button selected, a process of causing the container list page to be reread, and a process of closing the container update page.

Then, the document management device 10, when receiving this partner view container update request, changes the container configuration information about the partner view container of the communication target user within the container information database 14 into a content corresponding to the information set in the browsing request destination setting page and to the various items of information included in the partner view container creation request. Note that the operation of the document management device 10 when pressing the “browsing request destination setting” button and so on, is the same as the already-explained operation.

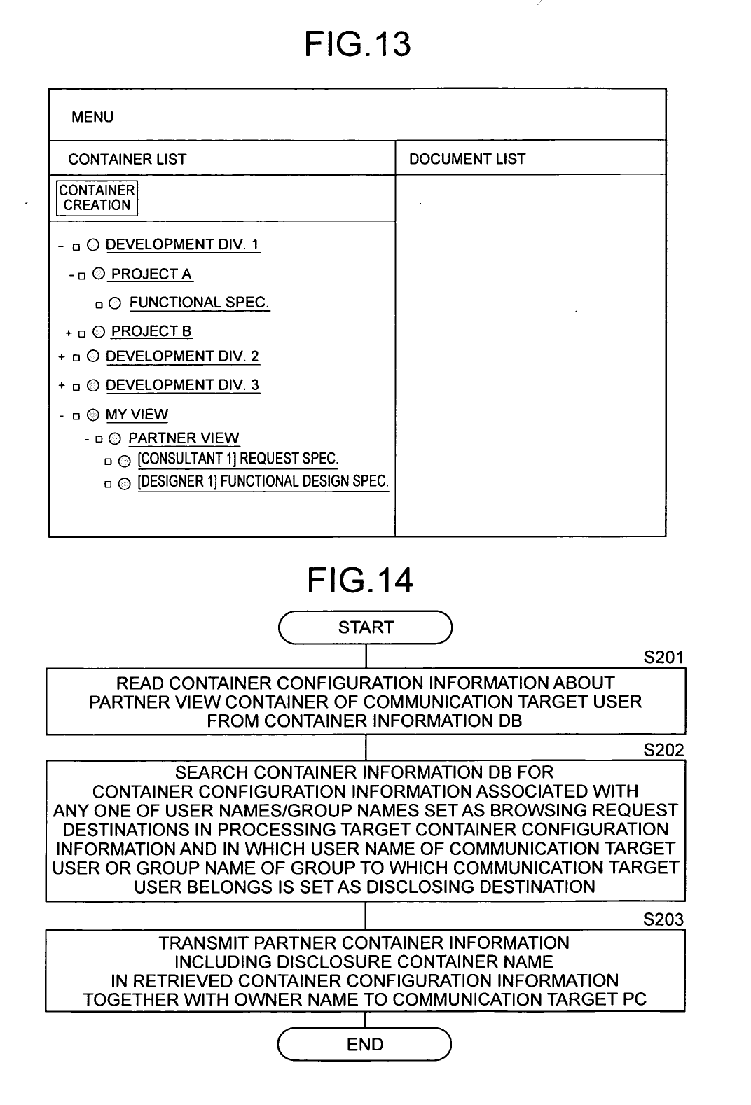

Further, as already described, if the container configuration information about the partner view container of the communication target user includes the information showing that the browsing request is made, the container list page data generated by the document management device 10 are organized for displaying the container list page displaying the “+” icon with respect to also the partner view container. Hence, after all, when the OK button on the partner view container update page is pressed after setting the browsing request destination, it follows that the content of the document list page is changed, for instance, from the content shown in FIG. 3 into a content shown in FIG. 13.

When the operation described above is performed by some users, the status is that the partner view container (in which the browsing request destination is set) of each user contains only the user container of the user designated as the disclosing destination in the user containers possessed by the individual users, which are designated as the browsing request destinations by the above users.

To be specific, the user, when desiring to utilize the user container of other user that is contained in the user's own partner view container, clicks the “+” icon related to the partner view container.

The document management device 10, which has received the partner container information request transmitted by this manipulation, at first, as shown in FIG. 14, reads from the container information database 14 the container configuration information (which will hereinafter be termed processing target container configuration information) about the partner view container of the communication target user (step S201).

Subsequently, the document management device 10 searches the container information database 14 for the container configuration information associated with any one of the user name/group name set as the browsing request destination in the processing target container configuration information and in which the user name of the communication target user or the group name of the group to which the communication target user belongs is set as the disclosing destination (step S202).

Then, the document management device 10 transmits, to the communication target PC 30, the partner container information in a predetermined format (enabling the processing of a script in the container list page data) that includes the disclosing container name in the retrieved container configuration information together with the owner's name in the container configuration information (step S203), and then terminates the processing in FIG. 14.

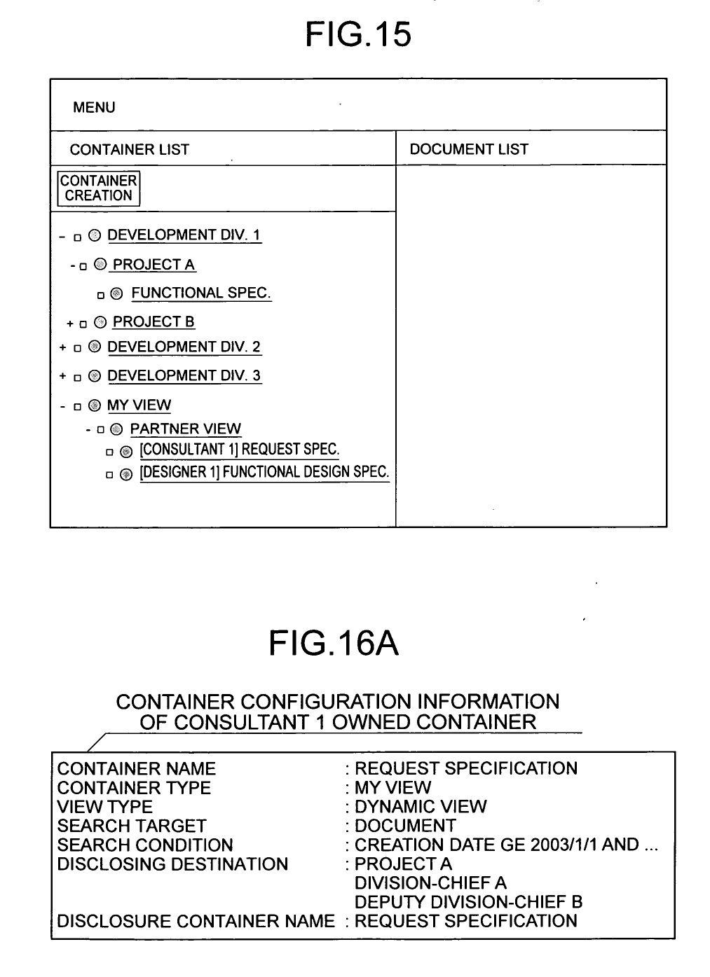

On the other hand, the communication target PC 30 receiving this partner container information executes a process of displaying, under the partner view container, links to the respective containers including the disclosing container names and the owner's names (wherein when clicking the link, a document list page showing a content of the associated container is displayed within a document list page frame) in the partner container information by use of the script in the container list page data. Then, as a result, the content of the document management page is changed into, for example, a content shown in FIG. 15.

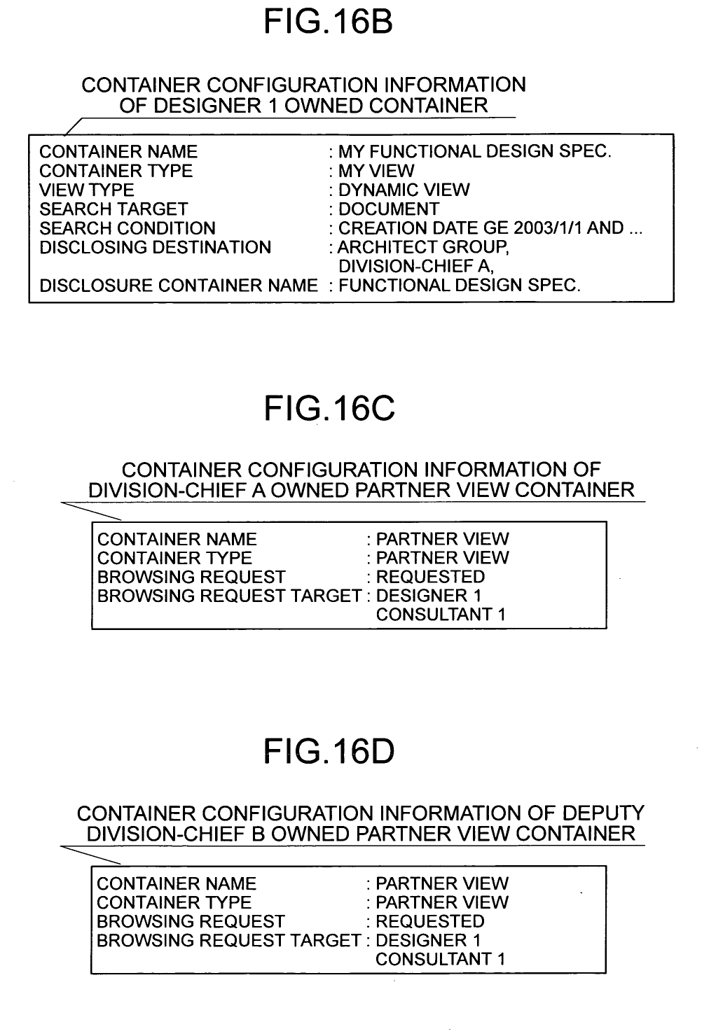

Note that the document management page shown in FIG. 15 has such a structure that a consultant 1 possesses the container having the container configuration information of which a content is as shown in FIG. 16A, a designer 1 possesses the container having the container configuration information of which a content is as shown in FIG. 16B and the container configuration information about the partner view container of a division-chief A has a content shown in FIG. 16C, wherein this document management page is displayed when the division-chief A manipulates the “+” icon related to the partner view container.

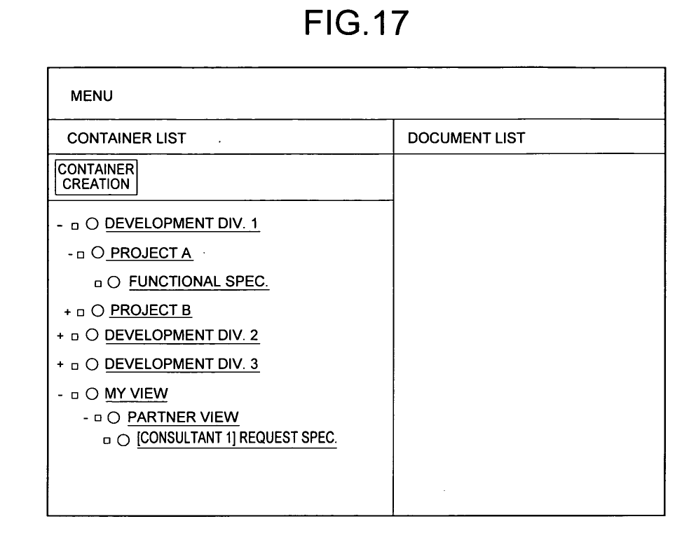

If a deputy division-chief B (with the same browsing request destination setting as the division-chief A) having the self partner view container of which the container configuration information has a content shown in FIG. 16D manipulates the “+” icon related to the partner view container, since the designer 1 does not designate the deputy division-chief B as the disclosing destination, as shown in FIG. 17 it follows that only the link to the container possessed by the consultant 1 is displayed under the partner view container.

Then, as obvious from the functions of the already-explained document management page and container creation page, the document management device 10 operates as follows in the case of receiving a HTTP request (which will hereinafter be referred to as a document list page request) transmitted by clicking the container name (link) on the container list page.

The receiving the document list page request specifies the container configuration information of the container with the document list page data that should be generated on the basis of the information (such as the container name, the user name and the disclosing container name) designating the container included therein. Then, the document management device 10, if “dynamic view” is entered in the view type in the specified container configuration information, searches for the document/container under the search condition designated (by part of information) in the container configuration information, then generates the document list page data having a content corresponding to a search result and sends this data back. While on the other hand, the document management device 10, if “static view” is entered in the view type in the specified container configuration information, generates the document list page data on the basis of the name information of the document/container included in this container configuration information, and sends this data back.

As described in detail so far, the document management device 10 in the present embodiment, after some users have executed the operation of setting the disclosing destinations in some self-containers (user containers) (or the operation of creating the containers in which the disclosing destinations are set) and after some users have performed the operation of setting the browsing request destinations in the self partner view containers, functions in such a status that the container names of the containers possessed by the users designated as the browsing request destinations by the user of the partner view container (in which the browsing request destinations are set) and related to the container group in which the owner designates these users as the disclosing destinations, are displayed under the partner view container. Accordingly, when employing this document management device 10, with respect to the container (the aggregation of the document names) that is not required by the user even if the owner discloses the container, the scheme is that the container name of this container is not displayed on the display of the PC 30. Further, the document management device 10 also has the function of displaying, on the display of the PC 30, the actual contents of the respective containers displayed under the partner view container. Hence, the documents required by the individual users can be easily searched by using this document management device 10.

### Modified Embodiments

The document management device 10 described above can be modified in a variety of forms. For instance, the document management device 10 can be modified into, e.g., a device 10 incapable of creating the fixed type container. Furthermore, the document management device 10 may also be modified into a device 10, wherein the setting of the disclosing destination/browsing request destination can not be done from on the PC 30 (the setting of the disclosing destination/browsing request destination is conducted from on a keyboard of the document management device 10).

Moreover, it is taken for granted that the specific structures of the various categories of Web pages provided by the document management device 10 may be differentiated from those described above, and that the document management device 10 may be modified into a device 10 requiring the PC 30 to be installed with a dedicated piece of client software.

What is claimed is:

1. A document management device comprising:
disclosing target designating information storage means for storing, with respect to each of a plurality of management target documents, disclosing target designating information showing a document owner and several use-enabled users permitted to use the document;
owner designating information storage means for storing, with respect to each of a plurality of users, owner designating information showing several document owners of the documents that the user desires to use; and
name information sending-back means for specifying, when a predetermined request is sent from a computer used by a certain user, all the documents possessed by any one of the owners indicated by the owner designating information stored on said owner designating information storage means with respect to the user concerned and of which the users are included in the use-enabled users indicated by the disclosing target designating information stored on said disclosing target designating information storage means from within the plurality of documents, and sending the name information about the specified document group back to said computer.

2. A document management device comprising:
a container information database capable of storing plural items of first type container information and plural items of second type container information on a user-by-user basis;
first type container information registering means for registering, based on information inputted by a certain user, said container information database with the first type container information including container content information defined as information indicating several document identifiers, container names and disclosing target designating information defined as information for designating several use-enabled users permitted to use the container content information as information about the containers possessed by the users concerned;
second type container information registering means for registering, based on the information inputted by a certain user, said container information database with the second type container information including the owner designating information indicating several owners of the documents that the user concerned desires to use as the information about the user concerned;
container name request response means for searching, when a predetermined container name request is sent from a computer used by a certain user, said container information database for all the first type container information about the container possessed by any one of the owners designated by the owner designating information included in the second type container information in said container information database with respect to the user concerned and including the disclosing target designating information indicating that the user concerned is the use-enabled user, and transmitting, to a computer that has transmitted the list information request, the container name information including the container names in the retrieved first type container information, the container names being displayed on a display of said computer; and
document identifier request response means for transmitting, when a document identifier request including a container name is sent from a computer that performs displaying based on the container name information, document identifier information stored on said container information database and including all of several document identifiers of the documents indicated by the container information in the first type container information including the container names, the document identifiers being displayed on the display of said computer.

3. A document management device according to claim 2, wherein said first type container information registering means is means for generating, as the container content information, the first type container information including dynamic container content information designating a document search condition or static container content information consisting of several document identifiers, and
said document identifier request response means is means for searching for, if the first container information stored on said container information database and including the container name contained in the document identifier request includes the dynamic container content information as the container content information, a document satisfying the search condition designated by the dynamic container content information from within management target documents.

4. A document management device according to claim 2 or 3, wherein the disclosing target designating information is information that includes several user names and several group names as the case may be, and
said container name request response means is means for dealing with the disclosing target designating information including the user name of the user and the disclosing target designating information including the group name of the group to which the user belongs as the disclosing target designating information indicating that the user is a use-enabled user.

5. A document management program for making a computer execute:
a first type container information registering process of registering, based on information inputted by a certain user, a container information database with the first type container information including container content information defined as information indicating several document identifiers, container names and disclosing target designating information defined as information for designating several use-enabled users permitted to use the container content information as information about the users concerned;
a second type container information registering process of registering, based on the information inputted by a certain user, said container information database with the second type container information including the owner designating information indicating several owners of the documents that the user concerned desires to use as the information about the containers possessed by the user concerned;
a container name request response process for searching, when a predetermined container name request is sent from a computer used by a certain user, said container information database for all the first type container information about the container possessed by any one of the owners designated by the owner designating information included in the second type container information in said container information database with respect to the user concerned and including the disclosing target designating information indicating that the user concerned is the use-enabled user, and transmitting, to a computer that has transmitted the list information request, the container name information including the container names in the retrieved first type container information, the container names being displayed on a display of said computer; and
a document identifier request response process of transmitting, when a document identifier request including a container name is sent from a computer that performs displaying based on the container name information, document identifier information stored on said container information database and including all of several document identifiers of the documents indicated by the container information in the first type container information including the container names, the document identifiers being displayed on the display of said computer.

6. A document management program for making a computer execute:
a disclosing target designating information registering process of registering, based on an instruction given from an owner of a plurality of management target documents, a document management database with disclosing target designating information showing several use-enabled users permitted to use the document on a document-by-document basis;
an owner designating information registering process of registering, based on instructions given from a plurality of users, said document management database with owner designating information showing several document owners of the documents that the user desires to use on a user-by-user basis; and
a name information sending-back process of specifying, when a predetermined request is sent from a computer used by a certain user, all the documents possessed by any one of the owners indicated by the owner designating information stored on said document management database with respect to the user concerned and of which the users are included in the use-enabled users indicated by the disclosing target designating information stored on said document management database from within the plurality of documents, and sending the name information about the specified document group back to said computer.
